(19) United States
(12) Patent Application Publication
(10) Pub. No.: US 2023/0175200 A1
(43) Pub. Date: Jun. 8, 2023

(54) FORMALDEHYDE-FREE AQUEOUS CURABLE COMPOSITION

(71) Applicants: Dow Global Technologies LLC, Midland, MI (US); Rohm and Haas Company, Collegeville, PA (US)

(72) Inventors: Yin Xue, Shanghai (CN); Zhaohui Qu, Shanghai (CN); Rui Shi, Shanghai (CN); Xinhong Wang, Shanghai (CN); Zhenbing Chen, Shanghai (CN)

(21) Appl. No.: 17/997,698

(22) PCT Filed: Jun. 19, 2020
(86) PCT No.: PCT/CN2020/097108

§ 371 Date: Nov. 1, 2022

(51) Int. Cl. D06M 15/263; C08F 4/76; C08F 18/14

(52) U.S. Cl. CPC D06M 15/263; C08F 4/76; C08F 18/14; C08F 2800/20

(57) ABSTRACT

The present disclosure relates to a formaldehyde-free aqueous curable composition comprising: A) a polymer polymerized from a monomer mixture comprising (a) 30-90 wt % of C₁-C₁₀ alkyl acrylate; (b) 10-60 wt % of vinylaromatics; (c) 0.5-10 wt % of an ethylenically unsaturated compound having at least two carboxylic acid groups; (d) 0-10 wt % of an ethylenically unsaturated acid having one carboxylic acid group; (e) 0-5 wt % of other ethylenically unsaturated monomers; wherein the percentages are based on the total weight of the monomer mixture; and B) a titanium catalyst.

### FIELD OF THE INVENTION

The present disclosure relates to a formaldehyde-free aqueous curable composition, in particular a formaldehyde-free aqueous curable composition used for paper, textile and nonwovens and also relates to an article comprising a substrate and a formaldehyde-free aqueous curable composition.

### INTRODUCTION

Traditional binders used in textile and nonwoven application contain N-Methylolacrylamide (NMA) as a functional monomer which brings binders excellent water resistance (wet strength) and solvent resistance (isopropyl alcohol strength) after cured. However, NMA containing binders release formaldehyde upon heating. A formaldehyde-free binder product with excellent water resistance (wet strength) and solvent resistance (isopropyl alcohol strength) after cured is desirable.

Accordingly, there is a strong need in the art for alternative formaldehyde-free aqueous curable compositions that have desirable performances such as excellent water resistance (wet strength) and solvent resistance (isopropyl alcohol strength) after cured.

### SUMMARY OF THE INVENTION

The present disclosure provides a formaldehyde-free aqueous curable composition that has desirable performances, such as excellent water resistance (wet strength) and solvent resistance (isopropyl alcohol strength, IPA strength) after cured.

The present inventors found that the introduction of a titanium catalyst, which is widely used in the synthesis of polyester, to an acrylate binder system can speed up curing process and bring excellent performances.

In a first aspect, the present disclosure provides a formaldehyde-free aqueous curable composition comprising:

A) a polymer polymerized from a monomer mixture comprising

(a) 30-90 wt % of C₁-C₁₀ alkyl acrylate;

(b) 10-60 wt % of vinylaromatics;

(c) 0.5-10 wt % of an ethylenically unsaturated compound having at least two carboxylic acid groups;

(d) 0-10 wt % of an ethylenically unsaturated acid having one carboxylic acid group;

(e) 0-5 wt % of other ethylenically unsaturated monomers;

wherein the percentages are based on the total weight of the monomer mixture; and

B) a titanium catalyst.

In a second aspect, the present disclosure provides an article comprising a substrate and a formaldehyde-free aqueous curable composition comprising:

A) a polymer polymerized from a monomer mixture comprising

(a) 30-90 wt % of C₁-C₁₀ alkyl acrylate;

(b) 10-60 wt % of vinylaromatics;

(c) 0.5-10 wt % of an ethylenically unsaturated compound having at least two carboxylic acid groups;

(d) 0-10 wt % of an ethylenically unsaturated acid having one carboxylic acid group;

(e) 0-5 wt % of other ethylenically unsaturated monomers;

wherein the percentages are based on the total weight of the monomer mixture; and

B) a titanium catalyst.

In a third aspect, the present disclosure provides a method of treating a substrate, comprising bringing an formaldehyde-free aqueous curable composition into contact with the substrate, and then drying and curing the formaldehyde-free aqueous curable composition, wherein formaldehyde-free aqueous curable composition comprising:

A) a polymer polymerized from a monomer mixture comprising

(a) 30-90 wt % of C₁-C₁₀ alkyl acrylate;

(b) 10-60 wt % of vinylaromatics;

(c) 0.5-10 wt % of an ethylenically unsaturated compound having at least two carboxylic acid groups;

(d) 0-10 wt % of an ethylenically unsaturated acid having one carboxylic acid group;

(e) 0-5 wt % of other ethylenically unsaturated monomers;

wherein the percentages are based on the total weight of the monomer mixture; and

B) a titanium catalyst.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, the term “composition”, “formulation” or “mixture” refers to a physical blend of different components, which is obtained by mixing simply different components by a physical means.

As disclosed herein, the term “Glass transition temperature” (T_{g}) can be measured by various techniques including, for example, differential scanning calorimetry (DSC) or calculation by using a Fox equation.

Throughout this document, the word fragment “(meth)acryl” refers to both “methacryl” and “acryl”. For example, (meth)acrylic acid refers to both methacrylic acid and acrylic acid, methyl (meth)acrylate refers to both methyl methacrylate and methyl acrylate, and (meth)acryamide refers to both methacryamide and acryamide.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, and the like.

The present disclosure provides a formaldehyde-free aqueous curable binder composition comprising:

A) a polymer polymerized from a monomer mixture comprising

(a) 30-90 wt % of C₁-C₁₀ alkyl acrylate;

(b) 10-60 wt % of vinylaromatics;

(c) 0.5-10 wt % of an ethylenically unsaturated compound having at least two carboxylic acid groups;

(d) 0-10 wt % of an ethylenically unsaturated acid having one carboxylic acid group;

(e) 0-5 wt % of other ethylenically unsaturated monomers;

wherein the percentages are based on the total weight of the monomer mixture; and

B) a titanium catalyst.

Preferably, the C₁-C₁₀ alkyl (meth)acrylate is C₁-C₈ alkyl (meth)acrylate. The C₁-C₈ alkyl (meth)acrylate can be selected from ethyl acrylate, ethyl methacrylate, propyl acrylate, propyl methacrylate, n-butyl acrylate and n-butyl, n-pentyl acrylate, n-pentyl methacrylate, n-hexyl acrylate, n-hexyl methacrylate, 2-ethyl hexyl acrylate, 2-ethyl hexyl methacrylate, or a mixture of any two or more of them. More preferably, the C₁-C₁₀ alkyl (meth)acrylate is selected from butyl acrylate, butyl methacrylate or a mixture thereof.

Preferably, the amount of C₁-C₁₀ alkyl (meth)acrylate (a) in the monomer mixture can be not less than 30% by weight, not less than 40% by weight, not less than 50% by weight, not less than 55% by weight, not less than 60% by weight, not less than 65% by weight, or not less than 70% by weight, but not greater than 90% by weight, preferably but not greater than 85% by weight, more preferably but not greater than 80% by weight. More preferably, the amount of C₁-C₁₀ alkyl (meth)acrylate is 55 to 85% by weight of the monomer mixture, or 70 to 80% by weight of the monomer mixture.

The monomer vinylaromatics (b) can be styrene, alpha-methylstyrene or a mixture thereof.

Preferably, the amount of vinylaromatics (b) in the monomer mixture can be not less than 10% by weight, preferably not less than 12% by weight, more preferably not less than 15% by weight, even more preferably not less than 18% by weight; but not greater than 60% by weight, preferably not greater than 50% by weight, more preferably not less than 40% by weight, even more preferably not greater than 30% by weight, still more preferably not greater than 25% by weight, or not greater than 20% by weight.

The ethylenically unsaturated compound having at least two carboxylic acid groups (c) are, for example, maleic acid, itaconic acid, fumaric acid or a mixture of any two or more of them.

Particular preference is given to itaconic acid.

Preferably, the amount of the ethylenically unsaturated compound having at least two carboxylic acid groups (c) in the monomer mixture can be not less than 0.5% by weight, preferably not less than 1% by weight, more preferably not less than 1.5% by weight, even more preferably not less than 2% by weight, but not greater than 10% by weight, preferably not greater than 8% by weight, more preferably not greater than 6% by weight, even more preferably not greater than 5% by weight, still more preferably not greater than 3% by weight.

The ethylenically unsaturated acid having one carboxylic acid group (d) can be acrylic and/or methacrylic acid. Preferably, the ethylenically unsaturated acid having one carboxylic acid group (d) is acrylic acid.

The ethylenically unsaturated acid having one carboxylic acid group (d) is an optional component. Preferably, the amount of ethylenically unsaturated acid having one carboxylic acid group (d) in the monomer mixture can be not less than 0.5% by weight, preferably not less than 1% by weight, more preferably not less than 1.5% by weight, even more preferably not less than 2% by weight, but not greater than 10% by weight, preferably not greater than 8% by weight, more preferably not greater than 6% by weight, even more preferably not greater than 5% by weight, still more preferably not greater than 3% by weight.

The other ethylenically unsaturated monomers (e) is an optional component and can be of any kind except (a)-(d). Suitable examples include a hydroxy-containing ethylenically unsaturated monomer, (meth)acryamide, or a phosphorous functional monomer. The hydroxy-containing ethylenically unsaturated monomer can be HEMA (hydroxylethyl methacrylate). The phosphorous functional monomer can be phosphorous-containing (meth)acrylates, such as phosphoethyl (meth)acrylate, phosphopropyl (meth)acrylate, phosphobutyl (meth)acrylate, salts thereof, and mixtures thereof, CH₂═C(R)—C(O)—O—(R_{I}O)ₙ—P(O)(OH)₂, wherein R=H or CH₃, R₁=alkyl, and n=2-6, such as SIPOMER PAM-100, SIPOMER PAM-200, and SIPOMER PAM-300 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, and mixtures thereof.

The amount of hydroxy-containing ethylenically unsaturated monomer in the monomer mixture can be not less than 0.1% by weight, preferably not less than 0.2% by weight, more preferably not less than 0.5% by weight, even more preferably not less than 0.8% by weight, but not greater than 5% by weight, preferably not greater than 4% by weight, more preferably not greater than 3% by weight, even more preferably not greater than 2% by weight, still more preferably not greater than 1.5% by weight.

Preferably, the monomer mixture of the present application does not comprise vinyl esters of C1-C18 alkanoic acid or α-olefin, such as ethylene or propylene.

In one preferred embodiment, the polymer A) is prepared by emulsion polymerization, and is therefore an emulsion polymer.

In the case of emulsion polymerization, a suitable surfactant system and/or protective colloids, or stabilizer is used.

Examples of suitable surfactant systems are those known in the art and include anionic, nonionic, cationic, or amphoteric emulsifiers and mixtures thereof. Examples of anionic surfactants include, but are not limited to, alkyl sulfates, sulfates of ethoxylate alcohols, aryl sulfonates, phosphates of ethoxylated alcohols, sulfosuccinates, sulfates and sulfonates of ethoxylated alkylphenols, and mixtures thereof. Examples of nonionic surfactants include, but are not limited to, ethoxylated alcohols, ethoxylated alkylphenols, and mixtures thereof. Examples of cationic surfactants include, but are not limited to, ethoxylated fatty amines. The typical weight of surfactant is 0.1 to 5.0 wt. % and more preferably 0.3 to 5.0 wt. % and most preferably 0.5 to 3.0 wt. % based on total weight of monomers. The surfactants are utilized by conventional methods that are well known in art. In one embodiment, the process to prepare the composition includes the emulsification of the monomer mix with the surfactant system prior to the polymerization reaction.

Examples of surfactant trade names are AEROSOL® A-102, Disponil® FES 77, Dowfax™ 2A1, Abex® 2535 and RHODACAL® DS-4.

Water-soluble initiators for the emulsion polymerization are, for example, ammonium salts and alkali metal salts of peroxodisulfuric acid, e.g., sodium peroxodisulfate, sodium persulfate, ammonium persulfate, hydrogen peroxide, or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing component comprises, for example, alkali metal salts of sulfurous acid, such as sodium sulfite, sodiumbisulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium bisulfite, and tert-butyl hydroperoxide/Na hydroxymethanesulfinate. The individual components, the reducing component for example, may also be mixtures: for example, a mixture of the sodium salt of hydroxymethanesulfinic acid with sodium bisulfite.

These compounds are mostly used in the form of aqueous solutions, the lower concentration being determined by the amount of water that is acceptable in the dispersion and the upper concentration by the solubility of the respective compound in water. The concentration is generally from 0.1 to 30% by weight, preferably from 0.5 to 20% by weight, with particular preference from 1.0 to 10% by weight, based on the solution.

The amount of the initiators is generally from 0.1 to 10% by weight, preferably from 0.3 to 5% by weight, based on the monomers to be polymerized. It is also possible for two or more different initiators to be used for the emulsion polymerization.

The emulsion polymerization takes place in general at from 30 to 130° C., preferably from 60 to 95° C. The polymerization medium may be composed either of water alone or of mixtures of water and water-miscible liquids such as methanol.

Preferably, only water is used. The emulsion polymerization may be conducted either as a batch operation or in the form of a feed process, including staged or gradient procedures. Preference is given to the feed process in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial charge to the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers, it is common to add initiator after the end of the actual emulsion polymerization as well, i.e., after a monomer conversion of at least 95%.

With the feed process, the individual components can be added to the reactor from the top, through the side, or from below, through the reactor floor.

In the case of emulsion polymerization, aqueous polymer dispersions with solids contents of generally from 15 to 75% by weight, preferably from 40 to 75% by weight, are obtained.

The polymer thus prepared is used preferably in the form of its aqueous dispersion.

The pH of the polymer dispersion is preferably adjusted to a pH of more than 4.5, and in particular to a pH of between 5 and 9.

The glass transition temperature of the polymer is preferably from −40 to 70° C., with particular preference from −30 to 65° C., and with very particular preference from −25 to 60° C. or −25 to 5° C.

The glass transition temperature can be determined by customary methods such as differential thermoanalysis or differential scanning calorimetry (see, for example, ASTM 3418/82, midpoint temperature).

Component B) is titanium catalyst.

The titanium catalyst has the formula of Ti(OR)₄ wherein each R is independently selected from the group consisting of an alkyl radical having from about 1 to about 30 carbon atoms, an alkenyl radical having from about 2 to about 30 carbon atoms, a cycloalkyl radical having from about 3 to about 30 carbon atoms, aralkyl radical having from about 6 to about 30 carbon atoms, and combinations of two or more thereof. Preferably, R is independently selected from the group consisting of an alkyl radical having from about 1 to about 12 carbon atoms, an alkenyl radical having from about 2 to about 12 carbon atoms, a cycloalkyl radical having from about 3 to about 12 carbon atoms, aralkyl radical having from about 6 to about 12 carbon atoms, and combinations of two or more of them. One or more hydrogen atoms of R is optionally substituted by halogen, —OH, —COOH, —NH₂, —CN, or —NH(C₁₋₁₀alkyl) or —N(C₁₋₁₀alkyl)₂ or is optionally interrupted by —C(═O)—, —C(═O)—NH—, phosphoryl, phosphoryloxy, sulfonyl or sulfonyloxy.

The titanium catalyst can be a complex of Ti and an organic polyacid, wherein the organic acid can be dibasic carboxylic acids, tribasic carboxylic acids, tetrabasic carboxylic acids or a mixture thereof, preferably, the organic acids can be selected from citric acids, tartaric acids, EDTA, malic acids, oxalic acids, glutaric acids, adipic acids, octanedioic acids, itaconic acids, or a mixture thereof.

Examples of component B) can be Tyzor ACtivate 436.

The amount of the titanium catalyst is 0.5-10 by weight per 100 parts by weight of the solids of polymer A), in particular 1 to 8, and very preferably 1.5 to 5 part by weight per 100 parts by weight of the solids of polymer A), more preferably 2 to 4 part by weight per 100 parts by weight of the solids of polymer A).

The component B) can be added at any point in the process. In one embodiment, it is added after the emulsion reaction.

Polymer A), or the aqueous dispersion of the polymer, can be mixed in a simple way with component B).

The aqueous composition may comprise further additives: a thickener, a defoamer, a wetting agent, a mechanical stabilizer, a pigment, a filler, a freeze-thaw agent, a neutralizing agent, a plasticizer, a tackifier (tackifying resin), an adhesion promoter, and combinations thereof. Examples of tackifiers are natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g. non-hydrogenated aliphatic C5 resins, hydrogenated aliphatic C5 resins, aromatic modified C5 resins, terpene resins, hydrogenated C9 resins, and combinations thereof.

Other compounds increasingly being used as tackifiers include polyacrylates which have a low molar weight. These polyacrylates preferably have a weight-average molecular weight MW of less than 30,000. With preference the polyacrylates are composed of at least 60% by weight, in particular at least 80% by weight, of C1-C8 alkyl (meth)acrylates.

Preferred tackifiers are natural or chemically modified rosins. Rosins are composed predominantly of abietic acid or its derivatives.

The amount by weight of tackifiers is preferably from 5 to 100 parts by weight, with particular preference from 10 to 50 parts by weight, per 100 parts by weight of polymer (solids/solids).

The curable aqueous composition may comprise 0 to 5 percent by weight of a thickener, based on the total weight of the binder composition. All individual values and subranges from 0 to 5 percent by weight are included herein and disclosed herein.

For example, the wt % of the neutralizing agent can be from a lower limit of 0, 0.5, or 1 percent by weight to an upper limit of 1, 3, or 5 percent by weight. Example thickeners include, but are not limited to, ACRYSOL™, UCAR™ and CELOSIZE™ which are commercially available from The Dow Chemical Company, Midland, Mich.

The curable aqueous composition may comprise 0 to 2 percent by weight of a neutralizing agent, based on the total weight of the binder composition. All individual values and subranges from 0 to 2 percent by weight are included herein and disclosed herein. For example, the wt % of the neutralizing agent can be from a lower limit of 0, 0.3, or 0.5 percent by weight to an upper limit of 0.5, 1, or 2 percent by weight.

Neutralizing agents are typically used to control pH to provide stability to the formulated binder composition. Examples of the neutralizing agent include, but are not limited to, aqueous ammonia, aqueous amines, and other aqueous inorganic salts.

The formaldehyde-free aqueous curable composition can be cured at a temperature from 120 to 200° C., preferably at a temperature from 150 to 180° C.

The formaldehyde-free aqueous curable composition can be used for a substrate such as paper, textiles or non-wovens to form an article

To treat the substrate, the substrate can be coated conventionally, such as dip coating, spray coating knife coating and the like, with the formaldehyde-free aqueous curable composition. Customary application rates are, for example, 5 to 50 g/m² (solids, without water).

The articles of the invention have good performance properties, in particular, great wet strength and/or IPA strength.

The present disclosure also provides a method of treating a substrate, comprising bringing an formaldehyde-free aqueous curable composition as described herein into contact with the substrate, and then drying and curing the formaldehyde-free aqueous curable composition.

The substrate can be paper, textiles or non-wovens.

Bringing an formaldehyde-free aqueous curable composition as described herein into contact with the substrate can be realized by dipping the substrate in the formaldehyde-free aqueous curable composition as described herein or spray coating the formaldehyde-free aqueous curable composition as described herein on the substrate.

### EXAMPLES

Some embodiments of the invention will now be described in the following Examples, wherein all parts and percentages are by weight unless otherwise specified.

### Raw Material:

TABLE 1
Raw Materials

| Material | Description | Vendor |
|---|---|---|
| Sodium Persulfate (SPS) | Oxidizing agent | Sinopharm Chemical |
| | | Reagent |
| RHODACAL DS-4 | Anionic surfactant | Cytec Solvay Group |
| sodium bisulfite (SBS) | Reducing agent | Sinopharm Chemical |
| | | Reagent |
| WHATMANTM #4 paper | | Whatman Ltd. |
| IPA | Isopropanol | Sinopharm Chemical |
| | | Reagent |
| TRITON ™ X-100 | A surfactant | The Dow Chemical |
| | | Company |
| BA (Butyl acrylate), Sty | Acrylic emulsion | The Dow Chemical |
| (Styrene), IA (Itaconic | monomers | Company |
| acid), AA(Acrylic acid); | | |
| HEMA (Hydroxyethyl | | |
| Methacrylate) | | |
| Tyzor Activate 436 * | Titanium Catalyst | Dorf Ketal |
| Bruggolite FF6 | Reducing agent | Brüggmann Chemical |
| t-BHP | Oxidizing agent | Sinopharm Chemical |
| (tert-butyl hydroperoxide) | | Reagent |

* Tyzor Activate 436 is a complex of Ti and citric acid, wherein the content of Ti is 5 wt %.

### Emulsion Polymerization Procedure

### Acrylic Emulsion (A):

| Sample | Composition | Note |
|---|---|---|
| SWX1321 (A-I1) | 59BA/35St/2.5AA/2.5IA/1HEMA | Inventive sample, |
| | | Tg = 5° C. |
| SWX1331 (A-I2) | 76BA/18St/2.5AA/2.5IA/1HEMA | Inventive sample, |
| | | Tg = −25° C. |
| SWX1336 (A-I3) | 76BA/19St/2.5AA/2.5IA | Inventive sample, |
| | | Tg = −25° C. |

1. Synthesis of Acrylic Emulsion (A)

SWX1321 including 590% BA, 350% Sty, 2.5% AA, 2.5% IA, 100 TEMA by weight based on the dry weight of the copolymer, was prepared according to below process.

Preparation of Monomer Emulsion (SWX1321)—5.77 g RHODACAL DS-4 (DS-4) was dissolved in 475 g deionized water (DI water). An emulsified monomer mixture was prepared by adding the following chemicals slowly to the agitated solution: 6.84 g IA, 13.7 g HEMA, 34.2 g AA, 806.6 gBA, 478.5 g Sty.

A solution containing 50.42 g DS4 and 370 g deionized water (“DI water” herein) were placed in a 5-necked, 5 liter round bottom flask equipped with a thermocouple, a cooling condenser and an agitator, and heated to 70° C. under nitrogen. 27.4 g Itaconic Acid (IA) in 255 g 60° C. DI water was charged into the flask. Then 82.8 g Monomer Emulsion was charged into the flask. Then 3.72 g Sodium Persulfate (SPS) in 25 g DI water, and 1.86 g sodium bisulfite (SBS) in 20 g DI water were charged into the flask. When the exotherm peak occurred and the temperature was at 70° C., the rest monomer emulsion, a solution of SPS (2.48 g in 50 g DI water) and a solution of SBS (1.24 g in 50 g DI water) were fed in 120 minutes. The polymerization reaction temperature was maintained at 69˜71° C. After the addition was completed, the vessel that contained the Monomer Emulsion and the feeding pipes leading into the flask were rinsed with 90 g DI water, and the rinse was added back to the flask. Then the flask was hold at 70° C. for 15 minutes. After that, solution of t-BHP (70%, 5.03 g in 48 g DI Water) and Bruggolite FF6 (4.28 g in 52 g DI Water) was added gradually over 60 minutes and the reaction was cooled to room temperature. 110 g 20% Sodium Hydroxide solution was added to adjust pH value to 6.5-7.5. The solid content was 46%.

SWX1331 including 76% BA, 18% Sty, 2.5% AA, 2.5% IA, 1% HEMA by weight based on the dry weight of the copolymer, was prepared according to below process.

Preparation of Monomer Emulsion (SWX1331)—47.72 g DS-4 was dissolved in 475 g deionized water (DI water). An emulsified monomer mixture was prepared by adding the following chemicals slowly to the agitated solution: 6.84 g IA, 13.7 g HEMA, 34.2 g AA, 1039.1 g BA, 246.1 g Sty.

A solution containing 8 g DS4 and 370 g deionized water (“DI water” herein) were placed in a 5-necked, 5 liter round bottom flask equipped with a thermocouple, a cooling condenser and an agitator, and heated to 70° C. under nitrogen. 27.4 g Itaconic Acid (IA) in 255 g 60° C. DI water was charged into the flask. Then 82.8 g Monomer Emulsion was charged into the flask. Then 2.48 g Sodium Persulfate (SPS) in 25 g DI water, and 1.24 g sodium bisulfite (SBS) in 20 g DI water were charged into the flask.

When the exotherm peak occurred and temperature was at 70° C., the rest Monomer Emulsion, a solution of SPS (2.48 g in 50 g DI water) and a solution of SBS (1.24 g in 50 g DI water) were fed in 120 minutes. The polymerization reaction temperature was maintained at 69˜71° C. After the addition was completed, the vessel that contained the Monomer Emulsion and the feeding pipes leading into the flask were rinsed with 90 g DI water, and the rinse was added back to the flask. Then the flask was hold at 70° C. for 15 minutes. After that, a solution of t-BHP (70%, 5.03 g in 48 g DI Water) and Bruggolite FF6 (4.28 g in 52 g DI Water) were added gradually over 60 minutes and the reaction was cooled to room temperature. 110 g 20% Sodium Hydroxide solution was added to adjust pH value to 6.5-7.5. The solid content was 46%.

SWX1336 was prepared according the same process with SWX1331, except the recipe of monomer emulsion: 47.72 DS-4 was dissolved in 475 g deionized water (DI water). An emulsified monomer mixture was prepared by adding the following chemicals slowly to the agitated solution: 6.84 g IA, 34.2 g AA, 1039.1 g Butyl Acrylate, 259.8 g Styrene.

2. Dry/Wet/IPA Tensile Strength Test

Above raw materials were formulated with proper agitation for 15 mins to obtain a curable aqueous composition according to the formulation in Table 2.

A piece of WHATMAN™ paper 28 cm×46 cm was dipped into 300 mL formulated emulsion. The treated substrate was padded by Mathis padder and then dried and cured at 150° C. for 3 minutes. The add-on of the polymer on paper was controlled between 14˜16%. The cured substrate was cut into pieces of 1 inch×4 inch wherein the 4 inch direction is the cross-machine (CD) direction of the paper. The tensile strength of specimens was tested under the treatment of dry (untreated), wet (after 30 minutes immersion in 0.1% Triton X-100/water solution) and IPA (after 30 minutes immersion in IsoPropanol) on Instron. The wet strength reflects the resistance of adhesive to water, and the IPA strength reflects the resistance of adhesive to solvent.

A saturated cellulosic substrate was evaluated for water resistance. The data were shown in Table 3.

TABLE 2
Formulation of Samples.

| Tyzor | | | | | Ratio of |
|---|---|---|---|---|---|
| ACtivate | A-I1 | A-I2 | A-I3 | A-C1 | B to A |
| 436 (B) | (46%) | (46%) | (46%) | (46%) | (Solids) |

| | | | | | |
|---|---|---|---|---|---|
| Comparative | | 100 | | | 0 |
| Example 1 | | | | | |
| Inventive | 0.92 | 100 | | | 2% |
| Example 1 | | | | | |
| Inventive | 1.84 | 100 | | | 4% |
| Example 2 | | | | | |
| Comparative | | | 100 | | 0 |
| Example 2 | | | | | |
| Inventive | 0.92 | | 100 | | 2% |
| Example 3 | | | | | |
| Inventive | 1.84 | | 100 | | 4% |
| Example 4 | | | | | |
| Comparative | | | | 100 | 0 |
| Example 3 | | | | | |
| Inventive | 0.92 | | | 100 | 2% |
| Example 5 | | | | | |
| Inventive | 1.84 | | | 100 | 4% |
| Example 6 | | | | | |

* Value in the bracket ( ) is the solid ratio in the formulation

TABLE 3
Application Test of Samples.

| | | Dry | Wet | | IPA | |
|---|---|---|---|---|---|---|
| | | strength | strength | | strength | |
| | Description | (kgf/inch) | (kgf/inch) | Δ* | (kgf/inch) | Δ* |
| Comparative | 100% A-I1 | 8.49 | 3.74 | | 2.89 | |
| Example 1 | | | | | | |
| Inventive | 2% B based on | 8.83 | 4.08 | 9.1% | 3.21 | 11.1% |
| Example 1 | solids of A-I1 | | | | | |
| Inventive | 4% B based on | 8.65 | 4.09 | 9.3% | 3.25 | 12.4% |
| Example 2 | solids of A-I1 | | | | | |
| Comparative | 100% A-I2 | 6.85 | 2.24 | | 2 | |
| Example 2 | | | | | | |
| Inventive | 2% B based on | 6.49 | 2.88 | 28.6% | 2.32 | 16% |
| Example 3 | solids of A-I2 | | | | | |
| Inventive | 4% B based on | 6.64 | 3.06 | 36.6% | 2.5 | 25% |
| Example 4 | solids of A-I2 | | | | | |
| Comparative | 100% A-I3 | 6.16 | 2.17 | | 1.37 | |
| Example 3 | | | | | | |
| Inventive | 2% B based on | 6.44 | 2.62 | 20.7% | 1.82 | 32.8% |
| Example 5 | solids of A-I3 | | | | | |
| Inventive | 4% B based on | 6.23 | 2.77 | 27.6% | 1.73 | 26.3% |
| Example 6 | solids of A-I3 | | | | | |

*Δ means the improvement of wet/IPA strength with B component in formulation.

The higher strength value stands for a better performance. Results from Table 3 shows all the examples are HCHO-free. Compared to Comparative Examples 1-3, Inventive Examples 1-6, with the B component in formulation, showed 9%˜ 40% improvements on wet strength, and 10˜40% improvement on IPA strength.

The improvement is believed to come from catalysis effect of titanium on reaction between carboxyl groups in the formulation and hydroxyl groups on the textile and non-woven substrate.

1. A formaldehyde-free aqueous curable composition comprising:
A) a polymer polymerized from a monomer mixture comprising
(a) 30-90 wt % of C₁-C₁₀ alkyl acrylate;
(b) 10-60 wt % of vinylaromatics;
(c) 0.5-10 wt % of an ethylenically unsaturated compound having at least two carboxylic acid groups;
(d) 0-10 wt % of an ethylenically unsaturated acid having one carboxylic acid group;
(e) 0-5 wt % of other ethylenically unsaturated monomers;
wherein the percentages are based on the total weight of the monomer mixture; and
B) a titanium catalyst.

2. The aqueous curable composition of claim 1, wherein the amount of C₁-C₁₀ alkyl acrylate in the monomer mixture is 55-85% by weight.

3. The aqueous curable composition of claim 1, wherein the C₁-C₁₀ alkyl acrylate is selected from ethyl acrylate, ethyl methacrylate, propyl acrylate, propyl methacrylate, n-butyl acrylate and n-butyl, n-pentyl acrylate, n-pentyl methacrylate, n-hexyl acrylate, n-hexyl methacrylate, 2-ethyl hexyl acrylate, 2-ethyl hexyl methacrylate, or a mixture of any two or more of them.

4. The aqueous curable composition of claim 1, wherein the vinylaromatics is selected from styrene, alpha-methylstyrene, or a mixture thereof.

5. The aqueous curable composition of claim 1, wherein the amount of vinylaromatics in the monomer mixture is 15-35% by weight.

6. The aqueous curable composition of claim 1, wherein the ethylenically unsaturated compound having at least two carboxylic acid groups is selected from maleic acid, itaconic acid, fumaric acid or a mixture of any two or more of them.

7. The aqueous curable composition of claim 1, wherein the ethylenically unsaturated acid having one carboxylic acid group is selected from acrylic acid, methacrylic acid or a mixture thereof.

8. The aqueous curable composition of claim 1, wherein the other ethylenically unsaturated monomers (e) is selected from a hydroxy-containing ethylenically unsaturated monomer, (meth)acryamide, or a phosphorous functional monomer.

9. The aqueous curable composition of claim 1, wherein the amount of the titanium catalyst is 0.5-10 by weight per 100 parts by weight of the solids of polymer A).

10. The aqueous curable composition of claim 1, wherein the titanium catalyst has the formula Ti(OR)₄ wherein each R is independently selected from the group consisting of an alkyl radical having from about 1 to about 30 carbon atoms, an alkenyl radical having from about 2 to about 30 carbon atoms, a cycloalkyl radical having from about 3 to about 30 carbon atoms, aralkyl radical having from about 6 to about 30 carbon atoms, and combinations of two or more of them, wherein one or more hydrogen atoms of R is optionally substituted by halogen, —OH, —COOH, —NH₂, —CN, or —NH(C₁₋₁₀alkyl) or —N(C₁₋₁₀alkyl)₂ or is optionally interrupted by —C(═O)—, —C(═O)—NH—, phosphoryl, phosphoryloxy, sulfonyl or sulfonyloxy;
or the titanium catalyst is a complex of Ti and an organic polyacid.

11. The aqueous curable composition of claim 1, wherein the glass transition temperature of the polymer is preferably from −40 to 70° C.

12. An article comprising a substrate and a formaldehyde-free aqueous curable composition according to claim 1.

13. The article of claim 12, wherein the substrate is paper, textiles or non-wovens.

14. A method of treating paper, textiles or non-wovens, comprising bringing an formaldehyde-free aqueous curable composition of claim 1 into contact with a substrate, and then drying and curing the formaldehyde-free aqueous curable composition.

15. The method of claim 14, wherein the substrate is paper, textiles or non-wovens.
